(19) United States
(12) Patent Application Publication
(10) Pub. No.: US 2009/0150924 A1
(43) Pub. Date: Jun. 11, 2009

(54) Using Two Electronic Programming Guides

(76) Inventor: Yue Heng Xu, Beaverton, OR (US)

Correspondence Address: Timothy N. Trop;TROP, PRUNER, HU & MILES, P.C., 1616 S. Voss Road, Suite 750, Houston, TX, 77057--263, US

(21) Appl. No.: 12/356,779

(22) Filed: Jan. 21, 2009

Related U.S. Application Data
(63) Continuation of application No. 09/409,366, filed on Sep. 30, 1999, now abandoned.

(51) Int. Cl. H04N 7/167

(52) U.S. Cl. 725/31

(57) ABSTRACT

A system enables a user to receive information about program content through a pair of electronic programming guides. A first electronic programming guide may be transported over the transport medium that also provides the program content. A second electronic programming guide may be accessed over a back channel. In one embodiment of the present invention, the second electronic programming guide may include more extensive information than the first electronic programming guide. In this way, the bandwidth available to transmit both program content and one or more electronic programming guides may be increased. Upon selection of a program through either the first or the second electronic programming guide, the program selection may be automatically initiated on the user's receiver.

### CROSS-REFERENCE TO RELATED APPLICATIONS

This application is a continuation of U.S. patent application Ser. No. 09/409,366, filed on Sep. 30, 1999.

### BACKGROUND

This invention relates generally to the use of electronic programming guides to make selections for video viewing.

Electronic programming guides are a popular ways of implementing video viewing selections. By providing a graphical user interface displaying, in chart form, a variety of different programming options at various times, the user can quickly see the available options and easily select from among those options. Generally, by implementing a mouse style selection of desired programming options, the user can automatically be coupled to the desired program. Similarly, the user can select programming, using an electronic programming guide, for later viewing.

One problem with electronic programming guides is that as the number of selections increases, the ability to download the programming guide over limited bandwidth connections become more troublesome. For example, the potential programming selections could exceed those currently available through broadcast and cable television systems. Potentially, users may select programming from a large number of Internet web sites for viewing through an electronic programming guide.

Generally, users access video information and electronic programming guides over airwave broadcasts, satellite systems, cable systems and over networks. Because of the large amount of data associated with video programming, the bandwidth of most available systems is taxed in providing not only the electronic programming guide but the video programming itself to a large number of users. With relatively compact electronic programming guides this is not a serious problem. However, as electronic programming guides expand in keeping with the expanding number of programming options, the available bandwidth may be unsuitable for transmitting, not only the video information, but extended electronic programming guides as well.

Thus, there is a need for better ways to access and use electronic programming guides.

### SUMMARY

In accordance with one aspect, a method of implementing an electronic programming guide through a program receiver includes providing access to a first electronic programming guide with a first set of program selections over a first medium. Access is provided to a second electronic programming guide with a second set of program selections over a second medium. The user is enabled to select, over the first and second media, programs for viewing on the receiver.

Other aspects are described in the accompanying detailed description and claims.

### BRIEF DESCRIPTION OF THE DRAWINGS

FIG. 1 is a schematic depiction of one embodiment of the present invention;

FIG. 2 is a flow chart showing software for using two different electronic programming guides;

FIG. 3 is a graphical user interface which may be used in connection with the software shown in FIG. 2;

FIG. 4 is a graphical user interface that may also be used in connection with the software shown in FIG. 2;

FIG. 5 is a graphical user interface that may be utilized in connection with software shown in FIG. 2;

FIG. 6 is a block depiction of hardware that may be utilized to implement the receiver shown in FIG. 1;

FIG. 7 is a flow for software resident on a receiver for implementing a more detailed embodiment of the software flow chart shown in FIG. 2;

FIG. 8 is a depiction of a hierarchical access system for an electronic programming guide;

FIG. 9 is a flow chart according to another embodiment of the present invention; and

FIG. 10 is a schematic depiction for a system for implementing the flow illustrated in connection with FIG. 9 in accordance with one embodiment of the present invention.

### DETAILED DESCRIPTION

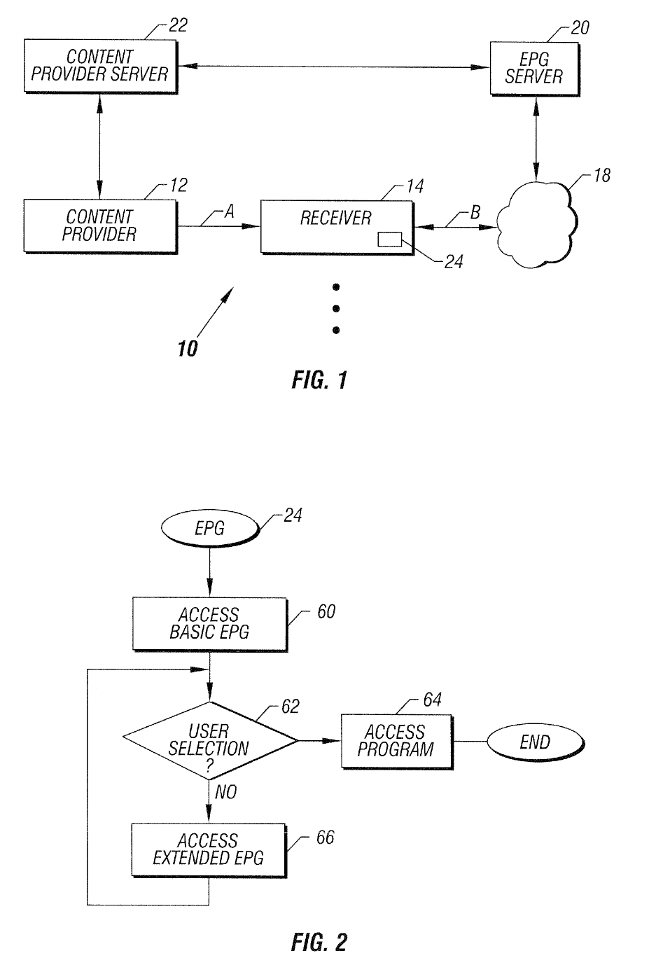

A video distribution system 10, shown in FIG. 1, makes available, over different transport media, two different electronic programming guides. The system 10 includes a content provider 12 which may also be known as a broadcaster in connection with airwave broadcasts. The content provider may provide video content over a variety of transport media including a satellite system, a cable system, a computer network or an airwave broadcast as examples. That information is transmitted over the desired medium to a plurality of receivers 14. The receivers 14 may be situated in users' homes for example.

The receivers 14 may be implemented as conventional broadcast television receivers or as processor-based systems. Suitable processor-based systems for implementing the receivers include the so-called set top computer systems, desktop computer systems, laptop computer systems, and processor-based appliances as examples. The processor-based receivers 14 may be coupled to a computer network 18.

The computer network 18 advantageously is an internetwork such as the Internet. However, the network 18 may also be implemented by a variety of networks including a Metropolitan Area Network (MAN), a wide area network (WAN) and even conceivably a local area network (LAN).

The network 18 is coupled to an electronic programming guide server 20 which provides a web site. The web site contains an extended electronic programming guide having all the available content which may be provided by the content provider 12. This content may include not only conventional broadcast video programs but also video programs made available through Internet connections. Thus, the electronic program guide may be relatively extensive in some embodiments of the present invention.

The electronic programming guide server 20 may communicate with a content provider server 22. The content provider server 22 provides the desired content such as video information and web site information to the content provider 12 which then broadcasts it to a plurality of receivers 14. Thus, the receivers 14 receive information from the content provider 12 through a first medium “A” and simultaneously may receive information through a back channel “B” coupled to the network 18.

In this way, the receivers may have access to an electronic programming guide provided by the content provider 12 together with the content over a desired transport medium. At the same time or prior thereto, each receiver 14 may access the more extensive electronic programming guide over the back channel. The back channel may be implemented, for example, by the electronic programming guide server 20 coupled to a network 18 such as the Internet.

Other combinations of back channel communications may be provided as well. For example, the user may receive television content from a cable provider while at the same using back channels in the form of a wide area network, a satellite system or a telephone link as examples. Thus, any combination of a main communication channel and a back channel may be utilized to implement embodiments of the present invention. In this way, the user may have access to an extended programming guide over a back channel which may not transmit as much program content as the primary channel of communication with the content provider 12.

Each receiver 14 may have software 24 stored on the receiver which implements the dual electronic programming guide system. Referring to FIG. 2, one embodiment of the software 24 provides access to a basic electronic programming guide as indicated in block 60. This access would typically be provided over the transport medium between the receiver 14 and the content provider 12. The basic electronic programming guide may have the most popular programs on the most popular stations together with a limited set of selections that the user has pre-selected for inclusion in a basic programming guide. The basic programming guide may, in one embodiment of the present invention, automatically appear when the electronic programming guide is selected. Commonly, electronic programming guides are selected through remote control units associated with processor-based systems.

As illustrated in diamond 62, upon user selection of an extended programming guide, the extended programming guide may be accessed (block 64). This access may be by way of the back channel through the network 18 in the embodiment illustrated in FIG. 1. In one embodiment of the present invention, the more extended electronic programming guide may include detailed information about a large amount of potential program content at a variety of different times.

Alternatively, the user can access a plurality of different electronic programming guides, for example associated with different web sites, each keyed to a different subject. For example, one site may provide an electronic programming guide for sporting events, another may provide an electronic programming guide for movies, and still another may provide an electronic programming guide for children's shows and the like. These more detailed guides may contain detailed information broken down by topic areas.

If the user does not make a selection on the basic programming guide as indicated in diamond 62, then the extended programming guide may be automatically accessed (block 66) in one embodiment of the present invention.

In either programming guide, the user generally makes selections using mouse-like commands. For example, by highlighting a given option in electronic programming guide (or positioning a cursor over the option) and selecting it using a mouse button, the user can cause the program to automatically be selected for viewing. Software for implementing such functions is well known in the art.

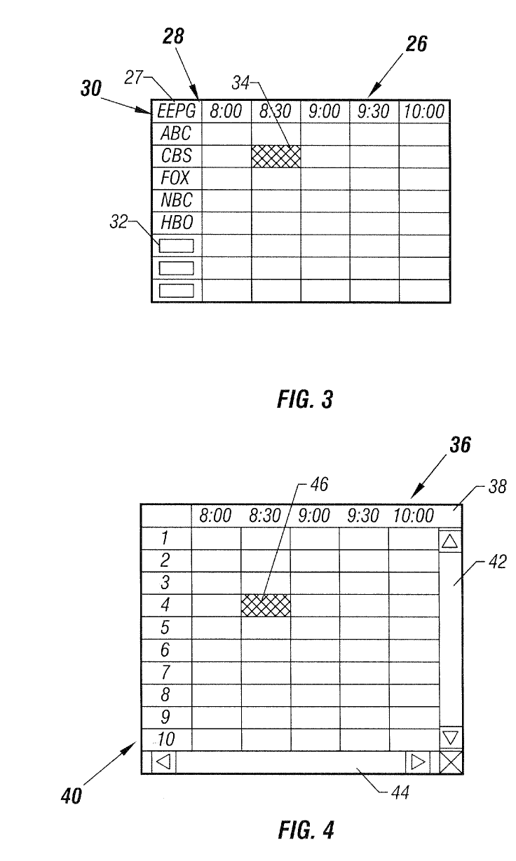

Referring to FIG. 3, an example of a basic electronic programming guide 26 includes a chart which has a plurality of times 28 forming columns and a plurality of channels or program sources 30 forming rows. The times in the columns 28 may be the current time and pre-selected intervals of time thereafter. The program sources listed in the column 30 may be primary sources such as conventional broadcast networks and pay televisions providers such as providers of movies as an example. In addition, the user may have a plurality of programmable entries 32 so the user can program favorite program sources to automatically appear in the user's electronic programming guide 26.

The user may select a desired program in a desired time slot by moving a cursor or other selection image to highlight a particular time and content provider as indicated at 34. By providing mouse click input commands, the user may select the desired entry. The mouse click operation may be implemented, for example, using a conventional mouse button and by moving the mouse to position the cursor where desired. Alternatively, a remote control unit with a plurality of cursor command buttons may be utilized to highlight the desired block in a well known fashion. The desired block may then be selected by pressing a button on the remote control unit, usually in close proximity to the cursor control buttons.

Referring next to FIG. 4, an extended electronic programming guide 36 may be implemented as a graphical user interface. This guide may include a very large number of potential channels indicated at 40 which may be selected using a scroll operator 42. The operator 42 enables the user to scroll up and down a long list of potential items using arrows. In addition, the user can scroll through a plurality of times 38 listed as columns in the electronic programming guide using a similar scroll operator 44. Thus, the user can simply scroll through a long list of potential entries and select a desired entry, as indicated in 46 and as described previously in connection with FIG. 3.

The user can have a basic electronic programming guide with limited selections as indicated in FIG. 3 and a more extensive electronic programming guide as indicated in FIG. 4. The more extensive guide may include all of the available entries both in terms of Internet programming and broadcast programming. Alternatively, it may have programs grouped by content or other basis. In such case, the user may need to access a plurality of extended electronic programming guides to locate all the potential programming information.

In any case, when a given program is selected, the program may be tuned for automatic viewing. Alternatively, as is well known in electronic programming guides, the selection of a program at a future time may cause that program to be automatically tuned in at the future time.

While FIGS. 3 and 4 illustrate electronic programming guides which are in the form of charts of potential programs and times, other formats may be utilized as well. For example, in connection with some systems, times may not be important, and instead a plurality of channels may each include a given number of programs that are available over any given time. The user may then select the programs which the user wants to view at a given time and the programs are provided at that time. Thus, in such cases, programs are not dedicated by the program provider to be broadcast at a given time slot. Instead, they can be provided when the user wants to view the program.

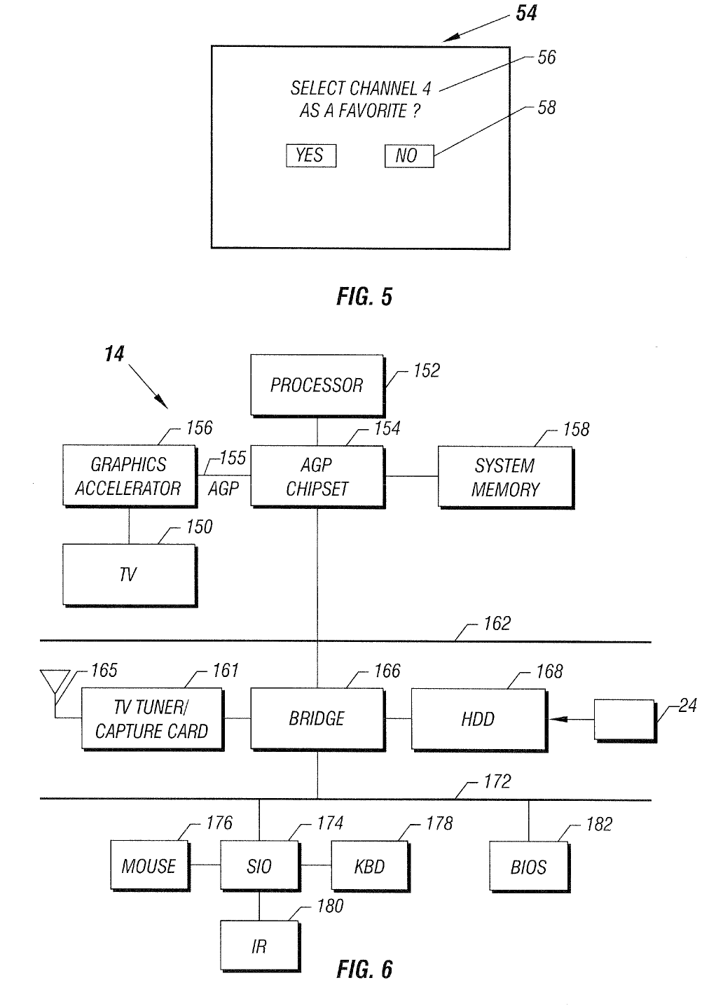

As indicated in FIG. 5, when the user selects a given program option 46 in the extended graphical user interface 36, the user may be prompted with a graphical user interface 54 to confirm the selection as the current selection as opposed to a selection to be added to the user's basic electronic programming guide. Thus, the user can select one of the icons 58 to respond to the inquiry 56. A similar graphical user interface can be provided, if the user indicated “no”, to enable the user to select the program as a channel on the user's basic graphical user interface 26, shown in FIG. 3. This may be done by filling one of the areas indicated at 32.

One embodiment for implementing the receiver 14 in accordance with the present invention, shown in FIG. 6, uses a processor 152. In one embodiment, the processor 152 may be coupled to an accelerated graphics port (AGP) (See Accelerated Graphics Port Interface Specification, Revision 1.0, published on Jul. 31, 1996 by Intel Corporation, Santa Clara, Calif.) chipset 154 for implementing an accelerated graphics port embodiment. The chipset 154 communicates with the AGP port 155 and the graphics accelerator 156.

A television 150 may be coupled to the video output of the graphics accelerator 156. The chipset 154 accommodates the system memory 158. The chipset 154 is also coupled to a bus 162. The bus 162 couples a TV tuner/capture card 161 which is coupled to an antenna 165 or other video input port, such as a cable input port, a satellite receiver/antenna or the like. The TV tuner/capture card 161 selects a desired television channel and also performs the video capture function. One exemplary video capture card is the ISVR-III video capture card available from Intel Corporation.

The bus 162 is also coupled to a bridge 166 which couples a hard disk drive 168. The software 24 may be stored on the hard disk drive 168. The bridge 166 is coupled to another bus 172. The bus 172 may be coupled to a serial input/output (SIO) device 174. The device 174 is in turn coupled to conventional components such as a mouse 176, a keyboard 178, and an infrared interface 180 for implementing a remotely controlled system. Also connected to the bus 172 is a basic input/output system (BIOS) 182.

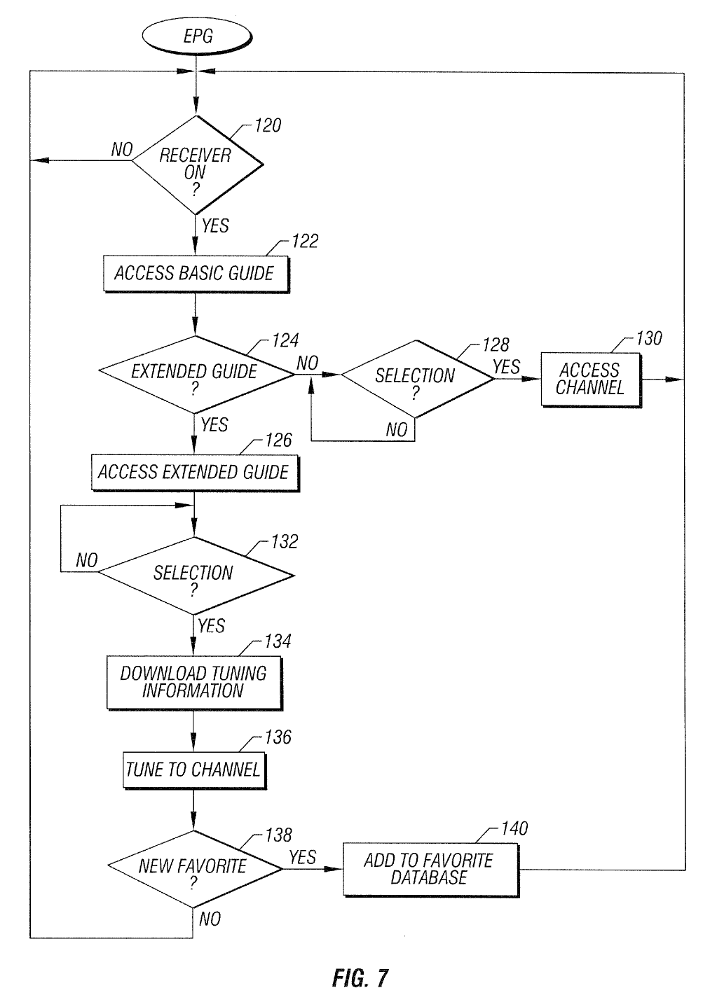

A more detailed version of the software 24, shown in FIG. 2, is illustrated in FIG. 7. Initially a check at block 120 determines whether the receiver 14 has been turned on. If so, the basic electronic programming guide may automatically be accessed as indicated in block 122. If the user selects the extended guide, for example by operating an icon 27 in FIG. 3, the extended guide may be substituted on the user's display screen in place of the basic guide. If not, the system waits for the user to make a selection, as indicated in diamond 128. When the user makes a selection, the selected channel may automatically be accessed, as indicated in block 130.

In the case where the user requests access to the extended programming guide, a connection to the extended programming guide is automatically implemented through the network 18 and the server 20 (block 126). The system then awaits a selection by the user (diamond 132) of a program in the extended electronic programming guide. When the selection is made, the information from the electronic programming guide may automatically be downloaded to the receiver 14 (block 134). The receiver 14 may then use the tuning information to tune to the desired channel from among the information provided by the content provider 12, as indicated in block 136. After the user has tuned to the channel, an inquiry (diamond 138) determines whether the user wishes to add the selection from the extended programming guide to the user's basic programming guide. If so, the new source may be added (block 140) to the list of sources in column 30 and FIG. 3 in one of the available spaces selectable by the user, as indicated at 32 in FIG. 3.

The user can use a basic electronic programming guide which includes the user's most likely selections and which consumes a reasonable amount of bandwidth. If this guide is inadequate, the user can select additional programming through a back channel such as may be available over the Internet. The user can then download the tuning information from the Internet based electronic programming guide for tuning to the desired program through a content provider.

In this way, the user is afforded the opportunity of making use of a large number of potential programming providers, each providing a large number of programs. The user can select from among those programs using a back channel without unduly burdening the primary transport medium (which provides the programming) with the need to provide extended programming guide information.

While the present invention has been illustrated in connection with an embodiment in which only one content provider is available, the system may also be used in systems having multiple content providers each of which makes available a different basic programming guide.

In accordance with one embodiment of the present invention, a hierarchical system may be utilized to access electronic programming guides. That is, the user can select, through a filtering system, a relatively refined set of program selections by progressively selecting from among ever narrowing options.

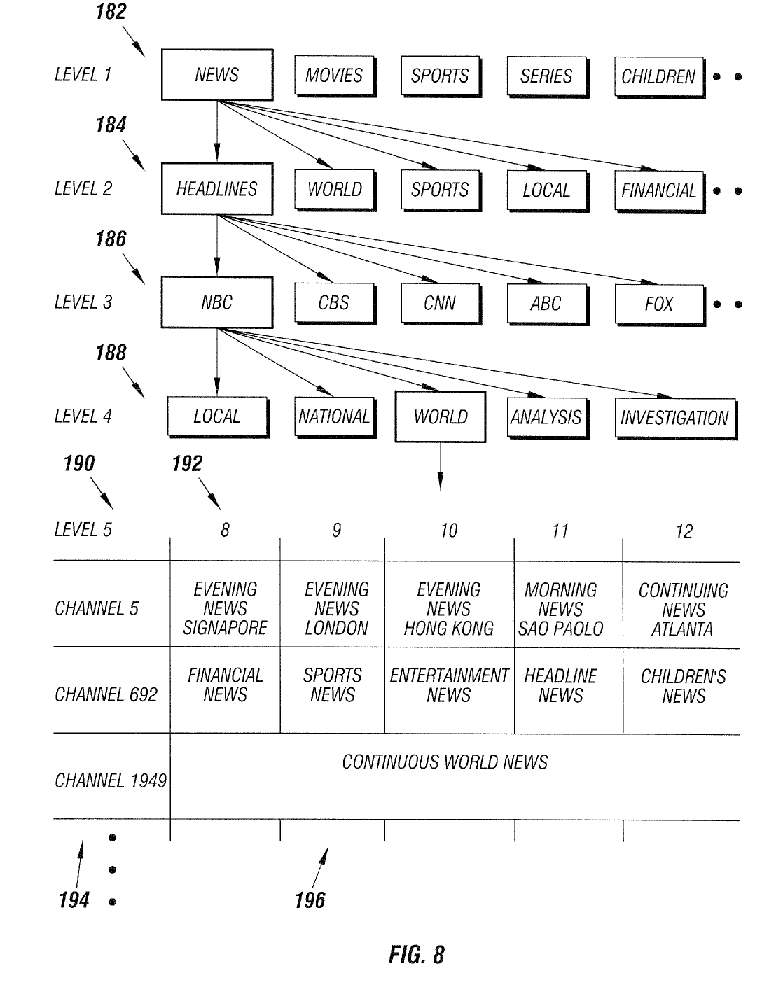

As shown in FIG. 8, at level 1, the user may be offered a plurality of general categories as indicated at 182. These topical categories may be displayed from information stored on each receiver 14. When the user selects one of the category topics, such as “news”, the level 2 display may occur, as indicated at 184. The category listed as 184 may again be resident in the memory system of the receiver 14 or alternatively may have been accessed remotely, for example over the Internet. Level 2 provides a series of categories within the category selected within level 1.

After the user makes a selection of one of the potential options afforded as level 2, another series of options may be afforded at level 3 as indicated at 186. Again, at this level, the different categories may be contained in resident storage on the receiver 14 or may be accessed over the Internet, for example through a different web site. In this case, a web site locator, such as a universal resource locator, may be obtained from information stored in association with the icon selected at level 2.

Thus, in each case, progressive information may be obtained through hyperlinks which are either absolute or relative. Relative hyperlinks access additional information within the same system whereas absolute hyperlinks access information through a different web site. In accordance with one embodiment of the present invention, the electronic programming guide information stored on the receiver 14 may be contained in the hierarchical arrangement and additional programming information may be thereafter obtained externally, in a hierarchical fashion, from one or more external web sites accessed over the Internet.

When the user makes a selection at level 3, such as “NBC”, the user may be provided at level 4 with a plurality of programming options as indicated at 188. In one embodiment of the present invention, a five level system is provided. That is, after level 4, a conventional electronic programming guide 190 may be displayed which displays a series of programs which may be available at different times.

Because of the filtering that has proceeded the display of the electronic programming guide 190, some channels and time entries may be excluded because they have no options in the pertinent time period. This may be advantageous since it allows a relatively lower amount of information to be transmitted to the receiver over an Internet connection. This is because the wealth of information that may be available has been filtered to provide the user with only the information which the user desires.

Thus, in connection with the example shown in FIG. 8, the electronic programming guide 190 may have a plurality of time slots from eight o'clock to twelve o'clock and a plurality of channels 194 including channels 5, 692 and 1949. Programs which are available within the displayed time periods are indicated in a grid display 196.

Where the selected programs at level 5 are retrieved from an Internet web site, that web site may also provide the necessary tuning information. Thus, when the viewer clicks on one of the options afforded in the electronic programming guide 190, that tuning information may be automatically linked to allow the user to automatically access the selected program.

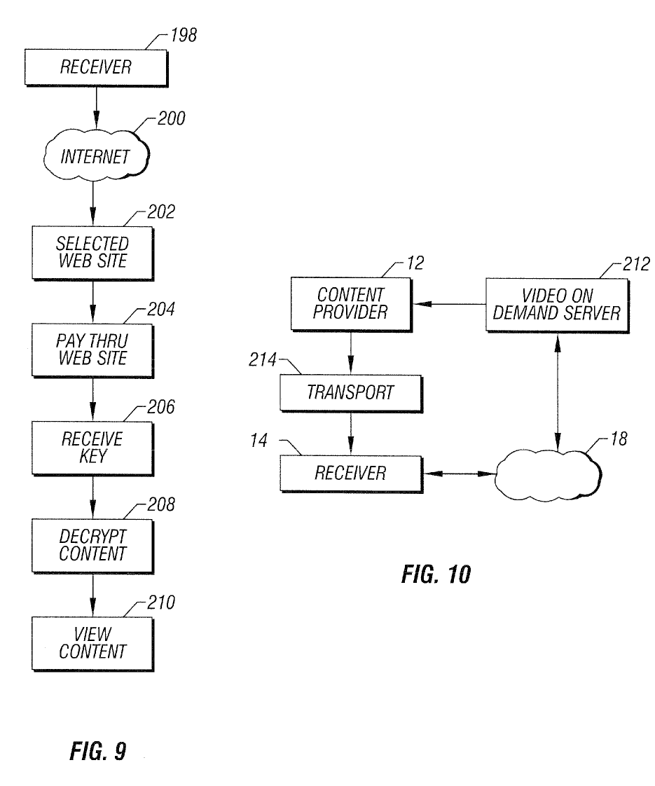

A video on demand system, shown in FIGS. 9 and 10, may be used in connection with the electronic programming guide selection techniques described above. That is, the techniques described so far may be utilized to access electronic programming guide information and ultimately program selections from a wide variety of local and Internet based resources. Those resources may include links to free programming as well as links to paid programming. Video on demand may be described as a system which provides video information to a receiver in response to the user's request for that information. Thus, instead of providing programming at predetermined times, programming may be provided in response to a user request. In many cases, video on demand systems may charge on a pay-per-view basis.

In accordance with some embodiments of the present invention, since the receiver 14 is already linked to the Internet to obtain electronic programming guide information, the Internet connection can also be used as a back channel to implement a user authorization system. The authorization system may be a system where the user is authenticated and authorized to view video on demand. The user may be charged for each item accessed at the time of accessing the information or may be charged against an account as two examples.

Referring particularly to FIG. 9, the receiver 198 communicates through the Internet 200 with a selected web site 202. That web site may have been selected based on electronic programming guide information which provided a pointer or a universal resource locator to a selected web site. The selected web site may provide access to or control access to video on demand information.

In some cases, the selected web site 202 may not be the actual content provider but instead may arrange with the content provider to allow access to video on demand. One reason for separating the content providing function and the content authorizing function may be that relatively limited numbers of bandwidth types may be available. For example, available bandwidths may include satellite transmissions, cable transmissions, and airwave broadcasts. Access to these media may be limited to a relatively small number of operators. Thus, other entities may secure bandwidth on the available transport media and may resell that bandwidth to consumers through an on demand video distribution system.

In accordance with one embodiment of the present invention, the selected web site may communicate with the receiver 198 to arrange for payment for the video on demand information either on an immediate charge basis, for example using credit card information, or by making a charge against the user's account as indicated in block 204. Once the user has been authenticated, the user may receive a key as indicated in block 206, for example from the selected web site. The key may be an identifier which identifies a unique code associated with the user's receiver together with additional information, such as frequency information, which enables the receiver to access the selected video.

The video on demand may have been continuously broadcast in one embodiment of the present invention. That video may now be decrypted, as indicated in block 208 and viewed, as indicated in block 210, using the newly acquired key.

Referring to FIG. 10, a system for implementing a video on demand scheme includes a receiver 14 which communicates over the Internet with one or more potential video on demand servers 212. Again, the video on demand servers 212 may be located using the electronic programming guide techniques described previously.

Once the authentication and payment arrangements have been made, the key may be transmitted from the server 212 through the Internet 18 to the receiver 14. This transmission may be appropriately encrypted to prevent interception.

At the same time, the server 212 may contact the content provider 12 and cause the content provider to transmit the authorized information through the transport medium 214 to the receiver 14. In another embodiment of the present invention, the video server simply provides the key to decode information which is already being broadcast through the transport medium 214 by the content provider 12.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
transmitting an electronic programming guide to a receiver over a transport medium;
receiving a request via said electronic programming guide for content;
arranging for payment for said content;
arranging, in return for said payment, for the transmission of a key to said receiver, said key to enable said content to be decrypted at said receiver; and
contacting a content provider to request that the content provider provide said content to said receiver over said medium.

2. The method of claim 1 including providing access to a first electronic programming guide with a first set of program selections.

3. The method of claim 2 including providing access to a second electronic programming guide with a second set of program selections wherein said second set of program selections is substantially more extensive than said first said of selections.

4. The method of claim 3 including enabling a user to select programs for viewing on said receiver from said first and second electronic programming guides.

5. An article comprising a medium for storing instructions that cause a processor-based system to:
transmit an electronic programming guide to a receiver over a transport medium;
receive a request via said electronic programming guide for content;
arrange for payment for said content;
arrange, in return for said payment, for the transmission of a key to said receiver, said key to enable said content to be decrypted at said receiver; and
contact a content provider requesting that the content provider provide said content to said receiver over said medium.

6. The article of claim 5 storing instructions to provide access to a first electronic programming guide with a first set of program selections.

7. The article of claim 6 storing instructions to provide access to a second electronic programming guide with a second set of program selections wherein said second set of program selections is substantially more extensive than said first said of selections.

8. The article of claim 7 storing instructions to enable a user to select programs for viewing on said receiver from said first and second electronic programming guides.
